(19) United States
(12) Patent Application Publication
(10) Pub. No.: US 2012/0159047 A1
(43) Pub. Date: Jun. 21, 2012

(54) COMPUTING DEVICE AND METHOD FOR MERGING STORAGE SPACE OF USB FLASH DRIVES

(75) Inventors: YAN LI, Shenzhen City (CN); DE-HUA DANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/300,613

(22) Filed: Nov. 20, 2011

(30) Foreign Application Priority Data
Dec. 20, 2010 (CN) 201010596708.X

(51) Int. Cl. G06F 12/02

(52) U.S. Cl. 711/103; 711/E12.008

(57) ABSTRACT

A method for merging storage space of multiple universal serial bus (USB) flash drives is applied in a computing device. The method detects USB flash drives plugged into USB ports of the computing device and checks respective storage capacities, stored files, and available storage space of the USB flash drives. A virtual USB flash drive including all the stored files of the USB flash drives is created. Files of the virtual USB flash drive are related to the USB flash drives. A file may be copied from a data processing device connected to the computing device to the virtual USB flash drive and split for storage between more than one USB flash drive, or a second file may be copied from one or more USB flash drives to the data processing device through the virtual USB flash drive.

### BACKGROUND

1. Technical Field

Embodiments of the present disclosure relate to data storage, and particularly to a computing device and method for merging storage space of multiple universal serial bus (USB) flash drives.

2. Description of Related Art

A plurality of USB flash drives may be used at the same time because of insufficient storage capacity of a single USB flash drive. However, usage of multiple USB flash drives may be inconvenient. For example, when a file needs to be stored in the USB flash drives, a user needs to select a suitable USB flash drive according to the size of the file and the storage capacities of each of the USB flash drives.

### BRIEF DESCRIPTION OF THE DRAWINGS

FIG. 1 is one embodiment of an application environment of a computing device for merging the storage space of USB flash drives.

FIG. 2 is a block diagram of one embodiment of a merge unit included in the computing device of FIG. 1.

FIG. 3 is a flowchart of one embodiment of a method for merging storage space of USB flash drives implemented by a computing device, such as that of FIG. 1.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of non-transitory computer-readable medium or other non-transitory storage device.

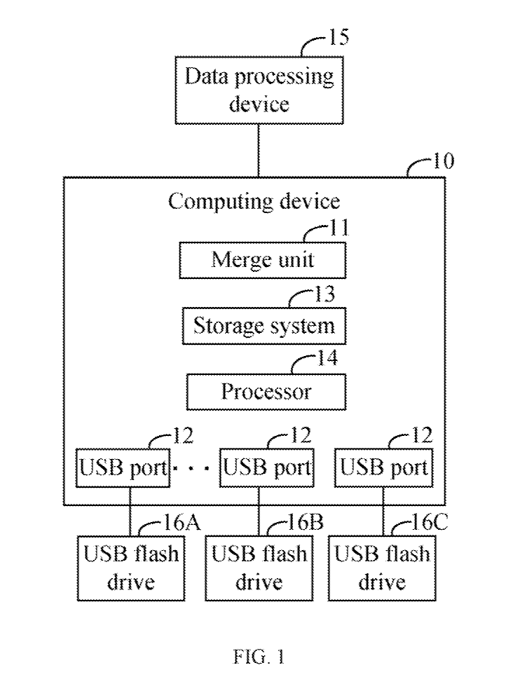

FIG. 1 is one embodiment of an application environment of a computing device 10 for merging storage space of several universal serial bus (USB) flash drives. In one embodiment, the computing device 10 includes a merge unit 11, a plurality of USB ports 12, a storage system 13, and at least one processor 14. The computing device 10 is connected to a plurality of USB flash drives 16 (e.g., 16A, 16B and 16C are shown in FIG. 1) via the USB ports 12. The computing device 10 is further connected to a data processing device (e.g., a computer) 15. In one embodiment, the computing device 10 is a USB hub that can connect with the USB flash drives 16 through the USB ports 12.

The merge unit 11 merges storage space of each of the USB flash drives 16 into a single large storage volume. In one embodiment, the merge unit 11 includes a number of function modules. The function modules may comprise computerized codes in the form of one or more programs that are stored in the storage system 13. The computerized codes includes instructions that are executed by the at least one processor 14 to provide functions for the modules of the merge unit 11. In one embodiment, the storage system 13 may be an internal storage device, such as a random access memory (RAM) for temporary storage of information, and/or a read only memory (ROM) for permanent storage of information. In some embodiments, the storage system 13 may also be an external storage device, such as an external hard disk, a storage card, or other data storage medium.

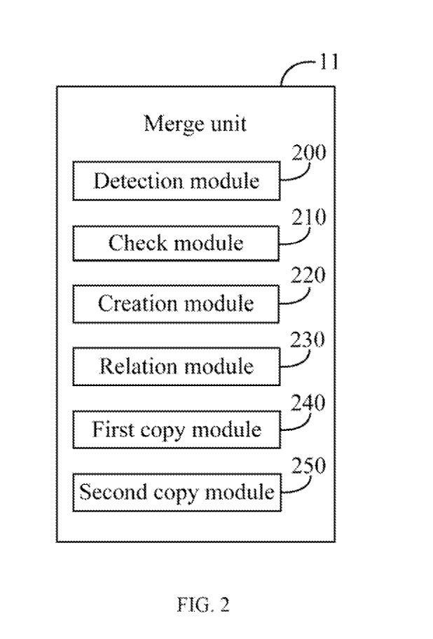

FIG. 2 is a block diagram of one embodiment of the merge unit 11. In the embodiment, the merge unit 11 may include a detection module 200, a check module 210, a creation module 220, a relation module 230, a first copy module 240, and a second copy module 250.

The detection module 200 detects any USB flash drive 16 plugged into the USB port(s) 12. In one embodiment, a USB flash drive 16 may trigger and sends an interrupt signal when plugged into the USB port 12. The detection module 200 detects the USB flash drive 16 upon receiving the interrupt signal. In one example with respect to FIG. 1, the detection module 200 has detected three USB flash drives, 16A, 16B, and 16C.

The check module 210 checks a storage capacity, stored files, and available storage space of each of the USB flash drives 16. The overall storage capacity of a USB flash drive 16 is equal to the sum of the storage space used by stored files and the available storage space of the USB flash drive 16. For example, the storage capacity of a USB flash drive 16 may be 2 GB, including 500 MB of storage space used by stored files plus 1.5 GB of available storage space. In one example with respect to FIG. 1, the check module 210 checks the individual storage capacities, the stored files, and the available storage space of each of the USB flash drives 16A, 16B, and 16C.

The creation module 220 creates a virtual USB flash drive that includes all the stored files of the USB flash drives 16, and has a storage capacity that is equal to a sum of all the USB flash drives 16. For example, the creation module 220 creates a virtual USB flash drive for the USB flash drives 16A, 16B, and 16C.

The relation module 230 relates files of the virtual USB flash drive to the USB flash drives 16 to indicate which of the USB flash drives 16 stores which of the files of the virtual USB flash drive. In one embodiment, the relation module 230 may create relationships between the files of the virtual USB flash drive and the USB flash drives 16 by applying a relational database.

The first copy module 240 copies a first file from the data processing device 15 to the virtual USB flash drive in response to a first copy request from a user. Specifically, the first copy module 240 selects one or more of the USB flash drives 16 according to the available storage space of the USB flash drives 16, and copies the first file from the data processing device 15 to the one or more of the USB flash drives 16. The first copy module 240 further adds the first file to the virtual USB flash drive, and relates the first file to the one or more of the USB flash drives 16. If a size of the first file is larger than the available storage space of any of the USB flash drives 16, the first copy module 240 splits the first file into multiple parts according to the available storage space of the USB flash drives 16, and accordingly stores the parts into the USB flash drives 16. In one embodiment, the first copy module 240 records a sequence of the parts of the first file. The sequence indicates an order of the parts in the first file. The parts of the first file can be recombined to recover the first file according to the sequence.

In one example with respect to FIG. 1, available storage space of the USB flash drives 16A, 16B, and 16C are 500 MB, 1.5 GB, and 2 GB respectively. A first file with a size of 4 GB is to be copied to the virtual USB flash drive. The first copy module 240 splits the 4 GB file into three parts with sizes of 500 MB, 1.5 GB, and 2 GB. The first copy module 240 copies the 500 MB part to the USB flash drive 16A, copies the 1.5 GB part to the USB flash drive 16B, and copies the 2 GB part to the USB flash drive 16C. Furthermore, the first copy module 240 adds the complete 4 G file to the virtual USB flash drive and relates the 4 G file to the USB flash drives 16A, 16B, and 16C. If the size of the first file is not larger than the available storage space of one of the USB flash drives 16, the first copy module 240 may copy the first file from the one of the USB flash drives 16 to the USB flash drive 16 directly.

The second copy module 250 copies a second file from the virtual USB flash drive to the data processing device 15 in response to a second copy request from the user. If the second file is related to more than one of the USB flash drives 16, which indicates that the second file is split into more than one part and is stored in the more than one of the USB flash drives 16, the second copy module 250 retrieves the parts of the second file from the more than one of the USB flash drives 16, recombines the parts to recover the second file, and copies the recovered second file to the data processing device 15. In one embodiment, the second copy module 250 recombines the parts to recover the second file according to the sequence recorded by the first copy module 240. If the second file is related to only one of the USB flash drives 16, the second copy module 250 copies the second file directly from the USB flash drive 16 to the data processing device 15.

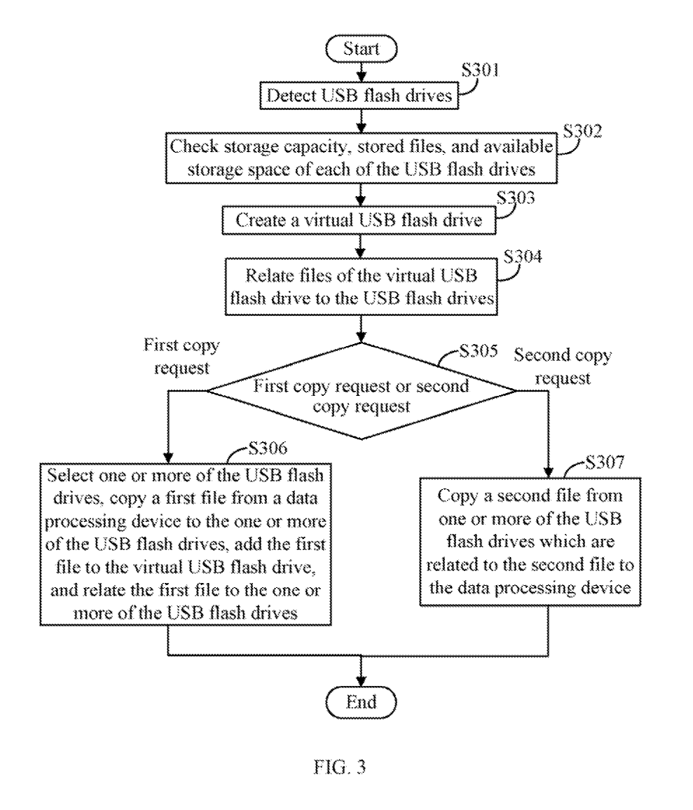

FIG. 3 is a flowchart of one embodiment of a method for merging storage space of several USB flash drives implemented by a computing device, such as that of FIG. 1. Depending on the embodiments, additional blocks may be added, others removed, and the ordering of the blocks may be changed.

In block S301, the detection module 200 detects any USB flash drives 16 plugged into the USB ports 12 of the computing device 10.

In block S302, the check module 210 checks a storage capacity, stored files, and available storage space of each of the USB flash drives 16.

In block S303, the creation module 220 creates a virtual USB flash drive that includes all the stored files of the USB flash drives 16, with a storage capacity that is equal to the sum of all the USB flash drives 16.

In block S304, the relation module 230 relates files of the virtual USB flash drive to the USB flash drives 16 to indicate which of the USB flash drives 16 stores which of the files of the virtual USB flash drive.

In block S305, a first copy request for copying a first file from the data processing device 15 to the virtual USB flash drive, or a second copy request for copying a second file from the virtual USB flash drive to the data processing device 15 is submitted by a user.

In response to the first copy request, in block S306, the first copy module 240 selects one or more of the USB flash drives 16 according to the available storage space of the USB flash drives 16, copies the first file from the data processing device 15 to the one or more of the USB flash drives 16. Furthermore, the first copy module 240 adds the first file to the virtual USB flash drive, and relates the first file to the one or more of the USB flash drives 16.

In response to the second copy request, in block S307, the second copy module 250 copies the second file from one or more of the USB flash drives 16 which are related to the second file to the data processing device 15.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device electronically connected to a data processing device, comprising:
a plurality of universal serial bus (USB) ports;
a storage system;
at least one processor;
a merge unit comprising one or more computerized codes, which are stored in the storage system and executed by the at least one processor, the one or more computerized codes comprising:
a detection module operable to detect USB flash drives plugged into the USB ports;
a check module operable to check a storage capacity, stored files, and available storage space of each of the USB flash drives;
a creation module operable to create a virtual USB flash drive that comprises all the stored files of the USB flash drives, with a storage capacity that is equal to a sum of all the USB flash drives;
a relation module operable to relate files of the virtual USB flash drive to the USB flash drives to indicate which of the USB flash drives stores which of the files of the virtual USB flash drive;
a first copy module operable to copy a first file from the data processing device to the virtual USB flash drive in response to a first copy request; and
a second copy module operable to copy a second file from the virtual USB flash drive to the data processing device in response to a second copy request.

2. The computing device of claim 1, wherein the computing device is a USB hub that connects to the USB flash drives through the USB ports.

3. The computing device of claim 1, wherein the first copy module selects one or more of the USB flash drives according to the available storage space of the USB flash drives, copies the first file from the data processing device to the one or more of the USB flash drives, adds the first file to the virtual USB flash drive, and relates the first file to the one or more of the USB flash drives.

4. The computing device of claim 3, wherein the first copy module splits the first file into parts according to the available storage space of the one or more USB flash drives and stores the parts into the one or more of USB flash drives, upon condition than a size of the first file is larger than the available storage space of any of the USB flash drives.

5. The computing device of claim 1, wherein the second copy module retrieves parts of the second file from more than one of the USB flash drives, recombines the parts to recover the second file, and copies the recovered second file to the data processing device, upon condition that the second file is related to the more than one of the USB flash drives.

6. A method for merging storage space of multiple universal serial bus (USB) flash drives of a computing device, the computing device comprising a plurality of USB ports and electronically connected to a data processing device, the method comprising:
detecting USB flash drives plugged into the USB ports;
checking a storage capacity, stored files, and available storage space of each of the USB flash drives;
creating a virtual USB flash drive that comprises all the stored files of the USB flash drives, with a storage capacity that is equal to a sum of all the USB flash drives;
relating files of the virtual USB flash drive to the USB flash drives to indicate which of the USB flash drives stores which of the files of the virtual USB flash drive;
in response to a first copy request, copying a first file from the data processing device to the virtual USB flash drive; and
in response to a second copy request, copying a second file from the virtual USB flash drive to the data processing device.

7. The method of claim 6, wherein the computing device is a USB hub that connects to the USB flash drives through the USB ports.

8. The method of claim 6, further comprising:
selecting one or more of the USB flash drives according to the available storage space of the USB flash drives;
copying the first file from the data processing device to the one or more of the USB flash drives;
adding the first file to the virtual USB flash drive; and
relating the first file to the one or more of the USB flash drives.

9. The method of claim 8, further comprising:
splitting the first file into parts according to the available storage space of the one or more of the USB flash drives and storing parts of the first file into the one or more of the USB flash drives, upon condition that a size of the first file is larger than the available storage space of any of the USB flash drives.

10. The method of claim 6, further comprising:
retrieving parts of the second file from more than one of the USB flash drives, recombining the parts of the second file to recover the second file, and copying the recovered second file is to the data processing device, upon condition that the second file is related to the more than one of the USB flash drives.

11. A non-transitory storage medium having stored thereon instructions that, when executed by a processor of a computing device that comprises a plurality of USB ports and connects to a data processing device, causes the processor to execute a method for merging storage space of multiple universal serial bus (USB) flash drives applied in the computing device, the method comprising:
detecting USB flash drives plugged into the USB ports;
checking a storage capacity, stored files, and available storage space of each of the USB flash drives;
creating a virtual USB flash drive that comprises all the stored files of the USB flash drives, with a storage capacity that is equal to a sum of all the USB flash drives;
relating files of the virtual USB flash drive to the USB flash drives to indicate which of the USB flash drives stores which of the files of the virtual USB flash drive;
in response to a first copy request, copying a first file from the data processing device to the virtual USB flash drive; and
in response to a second copy request, copying a second file from the virtual USB flash drive to the data processing device.

12. The medium of claim 11, wherein the computing device is a USB hub that connects to the USB flash drives through the USB ports.

13. The medium of claim 11, wherein the method further comprises:
selecting one or more of the USB flash drives according to the available storage space of the USB flash drives;
copying the first file from the data processing device to the one or more of the USB flash drive;
adding the first file to the virtual USB flash drive; and
relating the first file to the one or more of the USB flash drives.

14. The medium of claim 13, wherein the method further comprises:
splitting the first file into parts according to the available storage space of the one or more of the USB flash drives and storing parts of the first file into the one or more of the USB flash drives, if a size of the first file is larger than the available storage space of any of the USB flash drives.

15. The medium of claim 11, wherein the method further comprises:
retrieving parts of the second file from more than one of the USB flash drives, recombining the parts of the second file to recover the second file, and copying the recovered second file is to the data processing device, upon condition that the second file is related to the more than one of the USB flash drives.
